(19) United States
(12) Patent Application Publication
(10) Pub. No.: US 2024/0035693 A1
(43) Pub. Date: Feb. 1, 2024

(54) REAL-TIME AIRBORNE PATHOGEN MONITORING SYSTEM AND METHOD

(71) Applicant: Proxima Lighting Solutions Corp, North Vancouver (CA)

(72) Inventors: Vahid reza Nafisi, Tehran (IR); Yaser Mohammadian Roshan, North Vancouver (CA); Alireza Balaei Ghahjaverstani, Tehran (IR); Zahra Mousavian, Tehran (IR); Ensieh Fahimi-Kashani, Tehran (IR); Poopak Pir, Tehran (IR)

(21) Appl. No.: 18/227,379

(22) Filed: Jul. 28, 2023

Related U.S. Application Data
(60) Provisional application No. 63/393,155, filed on Jul. 28, 2022.

(51) Int. Cl. F24F 8/95; F24F 8/108; F24F 8/90; F24F 8/22

(52) U.S. Cl. CPC F24F 8/95; F24F 8/108; F24F 8/90; F24F 8/22

(57) ABSTRACT

A system for monitoring and screening pathogens in air particles and the methods of operation thereon are provided. The system includes an air sampling unit to collect airborne particles from ambient air, a cascade impactor sensory module to filter and measure the existence of airborne pathogens, and a processing unit to receive sensory measurements and analyze the measurements for detection of the pathogens. The sensory module may comprise multiple sensors disposed on multiple filtering stages of the module, wherein each sensor may be configured to identify various types of pathogens. The monitoring system may include a cleaning system configured to enable reuse of the sensory module for detection of pathogen among future air particles sampled from ambient. The monitoring system may further include a data transmitter to transmit processed data from the processing unit to display device that indicates the presence of a pathogen among air particles to a user.

### TECHNICAL FIELD

The present disclosure relates generally to screening the air for signs of specific airborne pathogens. More specifically, the present disclosure provides systems and methods for performing air sampling and monitoring existence of pathogens in air particles in real-time.

### INTRODUCTION

The pathogenic pandemics in the recent few decades (most notably the pandemic of COVID19 virus) demonstrated the vulnerability of buildings to the distribution of airborne pathogens. Not only the buildings do not usually have an adequate level of air quality and air circulation to remove the pathogens from the air, but in the basics, there are no commercially available pathogen monitoring systems that can be readily used in various rooms of a buildings.

The currently available devices are either being used for specific purposes or are limited in terms of type of pathogen (typically they are culturing bacterial colonies), or detection period (so they cannot be used for real-time monitoring). Therefore, there is still a need for a portable device that can be used in any room or facility and to detect the existence of a variety (or specific) types of airborne pathogens. At a minimum, such as device can alarm the building occupants of the existence of the pathogens in an effort to minimize the adverse effects. In more sophisticated systems, such a device can be connected to air circulation, air condition, or air disinfection devices to operate them based on the existence of pathogens in the air.

### SUMMARY

In accordance with one disclosed aspect, a system for real-time monitoring of an airborne pathogen in ambient air is provided. The system comprising: a sampling unit comprising a collection inlet and configured to collect airborne particles from ambient air; a cascade impactor comprising an inlet, an outlet, a plurality of filter stages and a sensor board disposed on a filter stage from the plurality of filter stages, the cascade impactor connected to the sampling unit from the inlet and configured to filter the airborne pathogen from the collected airborne particles, wherein the filtered airborne pathogen is identified by the sensor board; and a processing unit connected to the sensor board and configured to detect the airborne pathogen identified by the sensor board.

The system may further comprise a vacuum pump connected to the sampling unit through the cascade impactor and configured to suck the airborne particles from ambient air and drive the collected airborne particles through the cascade impactor.

The sensor board may be removable and may be replaced with a new sensor board after the airborne pathogen is detected.

The system may further comprise a cleaning system operably connected to the cascade impactor and configured to clear the cascade impactor and the sensor board thereon from the airborne pathogen. The cleaning system may comprise a cleaning fluid stored in a fluid storage, and a fluid pump connected to the fluid storage, the fluid pump configured to drive the cleaning fluid from the fluid storage and through the cascade impactor. The cleaning system may further comprise a fluid waste chamber connected to the outlet and configured to collect to the cleaning fluid after exiting the cascade impactor. The cleaning system may further comprise a cyclone disposed between the cascade impactor and the fluid waste chamber, and configured to separate the airborne particles form the cleaning fluid.

The system may further comprise a drying system configured to dry the cascade impactor from the cleaning fluid.

The cascade impactor may further comprise an ultraviolet light source to disinfect the sensor board from the airborne pathogen. The cascade impactor may comprise a first sensor board disposed on a first filter stage from the plurality of filter stages and a second sensor board disposed on a second filter stage from the plurality of filter stages, and wherein the first sensor board and the second sensor board are different and are configured to the identify a first airborne pathogen and a second airborne pathogen respectively.

The sensor board may comprise one or more coated crystals, wherein the sensor board identifies the airborne pathogen by a change in mechanical and/or electrical characteristic of the coated crystal once the airborne pathogen is in contact with the coated crystal. Accordingly, the system may further comprise a data transmission unit connected to the processing unit and configured to transmit data between the processing unit and a secondary device.

The system may further comprise a reference sensor board not exposed to the airborne particles and configured to provide a reference signal to the processing unit for detection of the airborne pathogen.

The processing unit may be operably connected to a display unit to indicate the detection of the airborne pathogen to a user.

In accordance with another aspect, a method for screening and monitoring an airborne pathogen in an environment is disclosed. The method comprising: sampling airborne particles from the environment and passing the airborne particles through a cascade impactor, wherein the cascade impactor comprises a plurality of filter stages and a sensor board disposed on a filter stage from the plurality of filter stages, and wherein at least one coated crystal is disposed on the sensor board; measuring, at the sensor board, signals related to electromechanical characteristics of the at least one coated crystal; receiving, at a processing unit, the measured signals from the sensor board; and detecting, by the processing unit, presence of the airborne pathogen among the airborne particles, at least partially due to a change in the electromechanical characteristics of the at least one coated crystal when the airborne pathogen is in contact with the coated crystal.

The sensor board may be removable and wherein the sensor board is replaced with a new sensor board after the airborne pathogen is detected.

The method may further comprise receiving, at the processing unit, a reference signal from a reference sensor and wherein detecting presence of the airborne pathogen is determined by comparing the measured signals from the sensor board with the reference signal.

The method may further comprise a cleaning cycle configured to clear the cascade impactor from the airborne pathogen once the airborne pathogen is detected, the cleaning cycle comprising one or more of the following steps: disinfecting the coated crystals from the airborne pathogen using an ultraviolet light source disposed on the sensor board; and cleaning the coated crystals and the cascade impactor by passing a cleaning fluid through the cascade impactor. The method may further comprise a drying cycle after the cleaning cycle.

### BRIEF DESCRIPTION OF THE DRAWINGS

The following figures set forth embodiments in which like reference numerals denote like parts. Embodiments are illustrated by way of example and not by way of limitation in the accompanying figures.

FIG. 1 shows the schematic diagram of a pathogen monitoring system according to an embodiment.

FIG. 2A shows an isometric view of the monitoring system of FIG. 1 according to an embodiment.

FIG. 2B shows a closer view of a portion of the system in FIG. 2A, according to an embodiment.

FIG. 3A illustrates an isolated view of the cascade sensory module of FIG. 2A.

FIG. 3B illustrates an exploded view of the cascade sensory module of FIG. 3A.

FIGS. 4A and 4B illustrate another embodiment of the cascade sensor module of FIG. 2A.

FIG. 5A to 5E are a series of isometric views showing isolated plates of the cascade sensory module of FIG. 2A.

FIG. 6A to 6C shows a series of views of the sensory board of the cascade sensory module of FIG. 2A.

FIGS. 7A and 7B show isometric views of the pathogen monitoring system of FIG. 1 according to another embodiment.

FIG. 8 provides a block diagram of a control and data acquisition system related to the sensor board of the pathogen monitoring system of FIG. 1, according to one embodiment.

FIG. 9A shows experimental results related to an exemplary pathogen monitoring system of the current disclosure.

FIG. 9B illustrates experimental results related to particle reduction performance of an exemplary pathogen monitoring system of the current disclosure.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects can be presented in a range format. It should be understood that the description in range format is merely for convenience and brevity and should not be construed as an inflexible limitation on the scope. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein are device, system, and methods thereon for monitoring airborne pathogens.

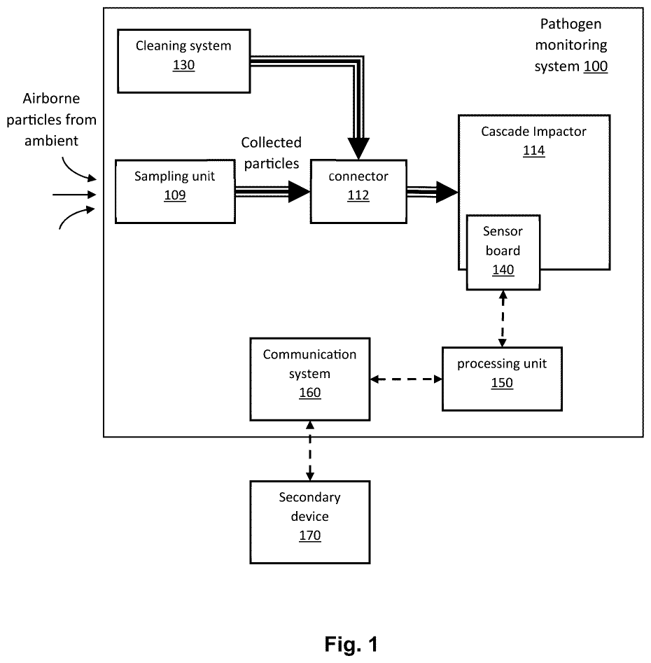

With reference now to schematic diagram in FIG. 1, a system for monitoring airborne pathogens in ambient air, is generally shown at 100, according to one embodiment. The system 100 comprises a sampling unit 109 configured to sample or collect airborne particles from ambient air and guiding the particles to a cascade impactor 114 through a connector 112.

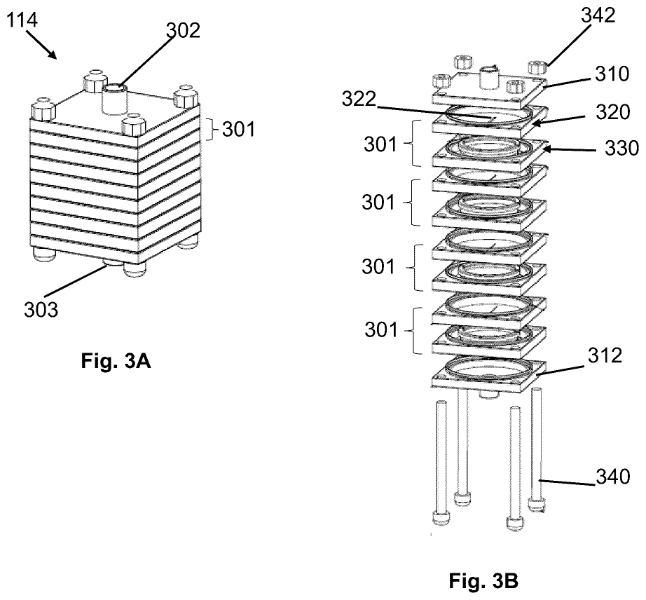

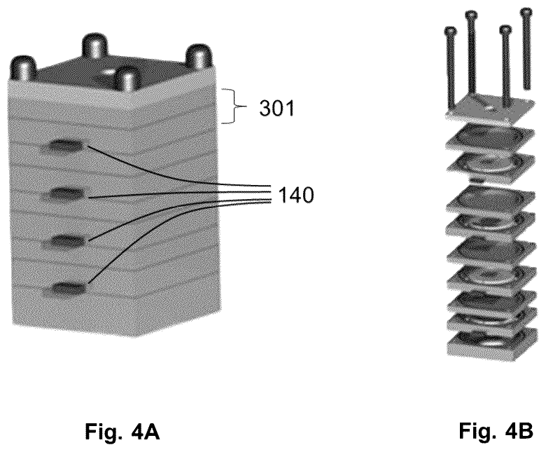

The cascade impactor 114 comprises one or more stages 301 (shown in FIGS. 3 and 4) and is configured to filter airborne particles with specific sizes as the collected airborne particles are passed through the cascade impactor 114. Each stage 301 of the multi-stage cascade impactor is designed to filter airborne particles with specific size ranges. The cascade impactor 114 further includes one or more sensor boards 140 disposed on one or more of the stages 301 and configured to sense measurements regarding airborne pathogens, such as harmful viruses, bacteria, and Fungi, among the airborne particles.

The system 100 further comprises a processing unit 150, which is in signal communication with the one or more sensor boards 140 and is configured to receive sensory measurements from the sensor boards 140 and detect presence of pathogens among airborne particles. Without loss of generality, the processing unit 150 may be a portable circuit board containing a microprocessor, a computer connected to the system 100 with wired or wireless connection, an internet/intranet-based processing system connected to the system 100 through wired or wireless internet/intranet connection, or any other similar processing unit. The processing unit 150 may also be a microcontroller, an FPGA, or an integrated circuit (IC), integrated to the sensor board 140 or remote from the sensor board 140, and operably configured to receive, analyze and process measurement signals from the one or more sensor boards 140 and determine if pathogen is present in the cascade impactor 114.

The system 100, may further include a communication or transmission system 160 operably connected to the processing unit 150 and configured to transmit data, such as pathogen detection data or system 100 status data, or any other data between the processing unit 150 and a secondary device 170, such as an indicator device or a display device configured to indicate or demonstrate the results of pathogen detection to a user through audio or visual indicators, for example. The secondary device 170 may also be a remote or local computer server configured to collect data of the pathogen monitoring system 100 and further processing the data, for example.

The pathogen monitoring system 100, may further include a cleaning system 130 operably connected to the cascade impactor through the connector 112 and configured to clean the cascade impactor from pathogens, for example after each time that a pathogen has been identified by the sensor boards 140. In this case, connector 112 may be a 3-way connector which can close the airway from the sampling unit and only allow a cleaning fluid (not shown in Figures) to pass through the cascade impactor 114 and clear the sensor boards 114 from the pathogens. The cascade impactor 114 may be referred to as cascade sensory module hereafter.

The system may further comprise a power unit (not shown in Figures), such as a Lithium-Ion battery, to power the electronics in the system 100.

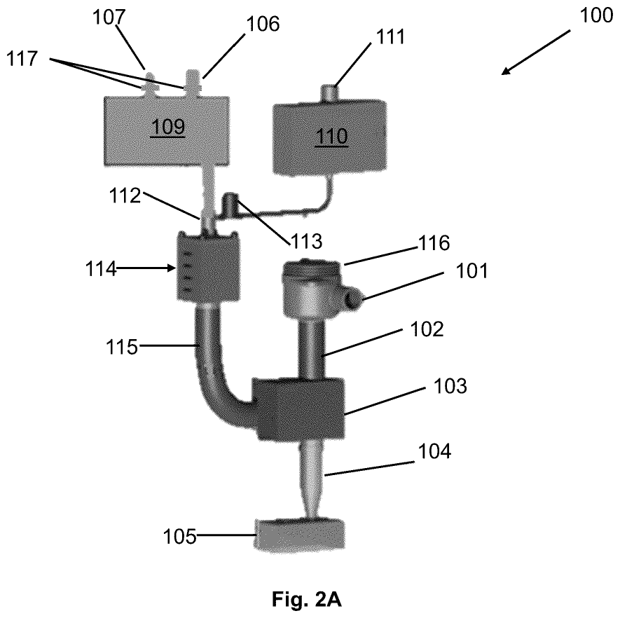

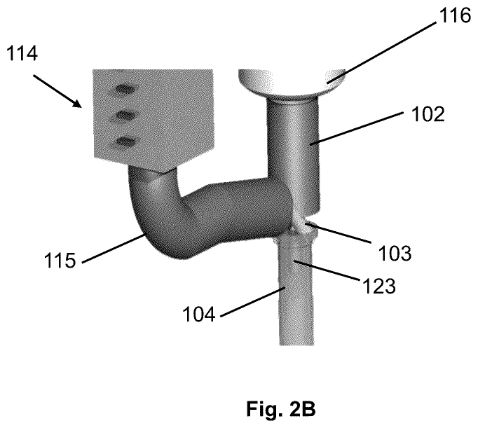

Referring to FIG. 2A, the pathogen monitoring system 100 is shown according to one embodiment. In this embodiment, the sampling unit 109 comprises an unfiltered inlet 106, which may be equipped with a switch valve 117 to selectively allow unfiltered air in the system 100. The switch valves may be manually controlled or may be connected to the processing unit 150 and receive command signals from the processing unit 150 to switched between close and open.

The pathogen monitoring system 100 may further include a vacuum pump 116 operably connected to the cascade impactor 114 and configured to generate an airflow to force the collection of airborne particles from ambient air and through the unfiltered inlet 106 of the sampling unit 109 and then through the multi-stage cascade impactor 114. The air is exhausted from the vacuum pump 116 through the pump outlet 101. The sampled air from the unfiltered inlet 106 of the sampling unit 109, passes through the connector 112 and to the cascade sensory module 114, and then through a connector pipe 115 to the pump connector pipe 102 and is exhausted through the outlet 101. The air passing through the cascade sensory module 114, will pass through one or more cascade stages 301 and also one or more sensor boards 140. Due to the physical shape of each stage 301, airborne particles with different sizes will be separated in different stages and will reside on the sensor at that level. The smaller airborne particles will move to the next level through the air flow.

The vacuum pump 116 is selected or designed in order to be capable of creating an airflow sufficient to pass the sampled airborne particles through the cascade sensory module 114. According to one embodiment, an airflow of at least 10 liters per minute may be needed to pass the sampled airborne particles through the cascade sensory module 114, and thus a vacuum pump capable of creating a minimum of 10 liter per minute is used. In one embodiment the vacuum pump 116 with the flow power of 300 liters per minute may be used to provide the adequate air flow in the cascade sensory module 114. It is worth noting that the 300 liters per minutes may be the nominal flow power of the pump 116 when it is not connected to the system 100 and when connected, the actual power may fall to smaller values due to the resistance through different pipes and components such as the cascade sensory module 114.

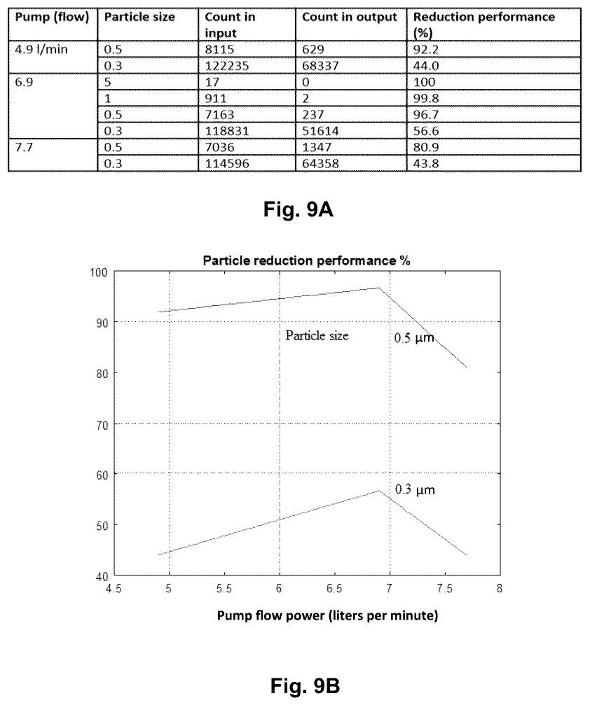

Referring to the table shown in FIG. 9A, referential experimental of the system 100 for airborne particles of 0.3 to 5 microns in diameter demonstrate that the best efficiency of the cascade sensory module 114 can be reached when the pump flow power is around 7 liters per minute. The experimental results are shown in the table of FIG. 9A, while the particle reduction performance is illustrated in FIG. 9B for two particle sizes of 0.5 and 0.3 microns in diameter.

Referring to FIGS. 3A and 3B now, an isometric view of the cascade sensory module 114 is shown in FIG. 3A and an exploded view is shown in FIG. 3B. The sensory module 114 includes air inlet 302, an air outlet 303, and a plurality of filter stages 301 stacked together, and a plurality of sensor boards 140 (as shown in FIG. 4A) disposed on each stage 301. Airborne particles cascade through various stages of the cascade impactor 114 while being trapped in a stage depending on the particle size. Each filter stage 301 includes a separator plate 320, which includes an air slot 322 for passing airborne particles with a specific size range, and a sensor holder plate 330 configured to hold the sensor board 140. Each stage 301 may vary in the size, the placement, and the orientation of the air slot 322, such that airborne particles and pathogens with specific size are captured in each stage, while particles and pathogens with smaller size may pass through to the next stage.

The cascade impactor 114 also includes a set of guide pins 340 and screws 342 to keep the stages 301 organized, in line, and compressed together. The cascade impactor 114 is airtight and airborne particles enter through the inlet 302 and only escape through the outlet 303. The cascade impactor 114 may further include a cap plate 310 and an end plate 312 to keep the cascade impactor enclosed and airtight and to prevent unintended air pressure reduction inside the impactor 114.

Referring to FIGS. 4A and 4B, the cascade impactor 114 is shown according to another embodiment. In FIGS. 4A and 4B, the sensor boards 140 are shown disposed on each filter stage 301.

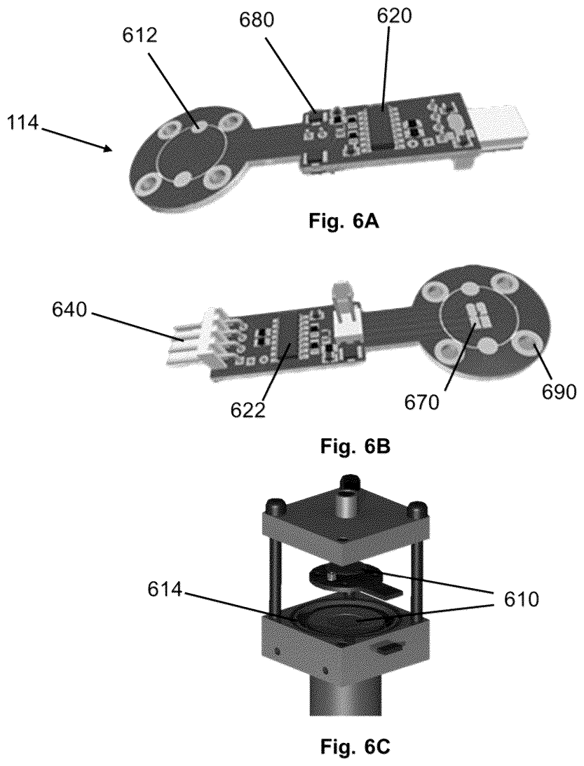

According to some embodiments, each sensor board 140 in each stage 301 of the cascade sensory module 114 includes a coated crystal 610 (shown in FIG. 6). Each coated crystal 610 has a specific chemical and biological coating which may react with a pathogen. Once the pathogen is in contact with the coated crystal 610, electromechanical properties, such as oscillation frequency or phase, of the crystal 610 may change and hence the sensor board 140 can sense the presence of the pathogen. Various chemical and biological coatings may be used to detect various pathogens. For example, to receive the pathogens of type Influenza A, Dextran Sulfate can be used as the biological coating.

In some embodiments, similar coated crystals 610 may be used in multiple stages 301 of the cascade impactor, for example to increase the reliability of the system 100 in monitoring a particular pathogen. However, in other embodiments, coated crystals with different coatings and properties may be used on different stages 301 of the cascade impactor 114 to provide detection measurements for various types of pathogens.

In some embodiments, after detection of the pathogens, the sensors may be reused for another round of pathogen detection by being cleaned using the cleaning system 130. Referring back to FIG. 2A, The cleaning system 130 may comprise a fluid storage 110 which contains a cleaning fluid (not shown in Figures), such as a disinfecting fluid such as an alcohol-based disinfection solutions, and a fluid pump 113 connected to the fluid storage 110 and configured to move the cleaning fluid to and through the cascade sensory module 114. The cleaning system 130 may further include a cyclone 104 to separate the cleaning fluid from airborne particles and a waste chamber 105 to store waste fluid from the cleaning fluid. The cleaning fluid can be of any material that can disinfect and clear the cascade impactor 114 and the sensors boards 140 from the pathogen particles. According to one embodiment the cleaning fluid is Glycine-HCl buffer with pH 3.0. In other embodiments, other cleaning fluids may be used.

In order to clear the sensor boards 140 from actual or potential pathogens a cleaning cycle is executed using the cleaning system 130. During the cleaning cycle, the cleaning fluid, which is supplied into the fluid storage 110 through a fluid input 111, is driven into and through the cascade sensory module 114 using the fluid pump 113. The cleaning fluid is configured to wash away the pathogens trapped into the cascade impactor 114 or bonded on the coated crystals of the sensor boards 140. After cleaning the sensor boards 140, waste fluid flows through the connector pipe 115 and into the cyclone 104. Going through the cyclone 104, the fluid is separated from the airborne particles. The remaining waste fluid is then drained into the waste chamber 105 while the airborne particles exhaust to through outlet 101. In some embodiments, there might be a check valve between the cyclone 104 and the waste chamber 105 to prevent air to be sucked into the cyclone 104 from the waste chamber 105.

In some embodiments, the system 100 may include a liquid sensor 103 attached to the middle of the cyclone to ensure that the cyclone is not filling up, incidentally. The liquid sensor 103 is configured to send a signal to a controller, such as the processing unit 150, to deactivate the liquid pump 113. In some embodiments the processing unit 150 may notify a user, for example through the secondary device 170, to troubleshoot the system 100 by discarding the liquid waste in the waste chamber 105.

According to some embodiments the system 100 may include a liquid sensor, similar to the liquid sensor 103, attached to the fluid chamber 110 and configured to notify a user when the cleaning fluid is finished or needs resupply.

FIG. 2B shows a closer view of the cyclone 104 connections to the vacuum pump 116 and the cascade sensory module 114. The cascade sensory module 114 is connected to the cyclone 104 through the connector pipe 115, while the vacuum pump 116 is also connected through the pump connector pipe 102. The liquid sensor 103 may be disposed on top of the cyclone 104 to indicate the fullness level of the cyclone and facilitate preventing cyclone 104 to fill up. In some embodiments, a humidity sensor 123 is disposed in the connector pipe to monitor the level of humidity in the airflow pathway.

In some embodiments, after the cleaning cycle and disinfection of the cascade impactor and the sensor boards 140, the sensor boards 140 may go through a drying cycle in order to be prepared for the next pathogen detection cycle. To do so, a heater may be disposed on the system 100 and configured to facilitate evaporation of excess fluid in the cascade impactor 114. The heater, for example, may be a heating blanket (not shown in Figures) in proximity to the cascade impactor 114 and configured to heat the enclosure of the cascade sensory module 114 and hence causing the evaporation of the fluid on the sensor boards 140. The heater, may be a set of heating elements 614 (shown in FIG. 6C) disposed inside the cascade impactor 114 and connected to the system's 100 power source and is being controlled by the processing unit 150. As will be described under FIG. 6A, the sensor board 140 may include a temperature sensor 680 configured to monitor the temperature of the sensor board 140. The measurements from the temperature sensor 680 may be transmitted to the processing unit 150. The processing unit 150 may shut down the heaters to prevent the temperature from rising to levels that damage the functionality of the sensor boards 140 and the overall system 100.

In some embodiments, the drying cycle may include an air dry step as well. In this step, filtered air may be sucked into the system 100 through a filtered inlet 107 of the sampling unit 109 and using the vacuum pump 116 so that filtered air replaces the evaporations in the cascade impactor 114. The filtered inlet 107 and unfiltered inlet 106 are being controlled (turned on and off) through the electric valves 117 installed on their airflow path. The filtered inlet 107 ensures that the new air in the cascade sensory module 114 is clean and does not contain any airborne pathogens, through using a high efficiency particulate air HEPA filter. The humidity sensor 123 may also be used in the air flow path to ensure that the air flow is dry and the drying cycle is completed. If humidity is not below a certain threshold, the drying cycle may continue until the humidity is within an acceptable level.

In some embodiments, the cleaning system 130 may also include Ultraviolet (UV) light sources (not shown in Figures) such as UV Light Emitting Diode (LED) disposed inside the cascade impactor 114 or on the sensor boards 140, and configured to inactivate the pathogens n vicinity of the sensor boards 140. In some embodiments, before starting a cleaning cycle using the cleaning fluid, the UV light sources, lights up the enclosure with UV light, for example in the wavelength range of 140 to 200 nm or more particularly with a wavelength of 185 nm. The UV light may release ozone in the enclosure which may inactivate the pathogens and/or reduce strength of the pathogens' bonds with the sensor boards 140. This UV treatment stage may facilitate that the pathogens are cleared more effectively during the cleaning cycle using the cleaning fluid.

In some embodiments, the cleaning system 130 is only the UV light sources and no cleaning fluid is used to clear the sensor boards 140 from the pathogens.

In some embodiments, the system 100 may not include the cleaning system 130 and instead the sensor boards 140 may be configured to be replaceable or swapable. In such embodiments, each time that a pathogen is detected by a sensor board 140, the sensor board may be taken out easily and replaced by a new sensor (i.e. test kit).

Without loss of generality, the detailed description below describes how the first embodiment works. The second embodiment is working with the same approach while disinfection parts such as the disinfectant chamber 110, liquid pump 113, 3-way pipe 112, cyclone 104, waste chamber 105, and the related connections and pipes, are not needed.

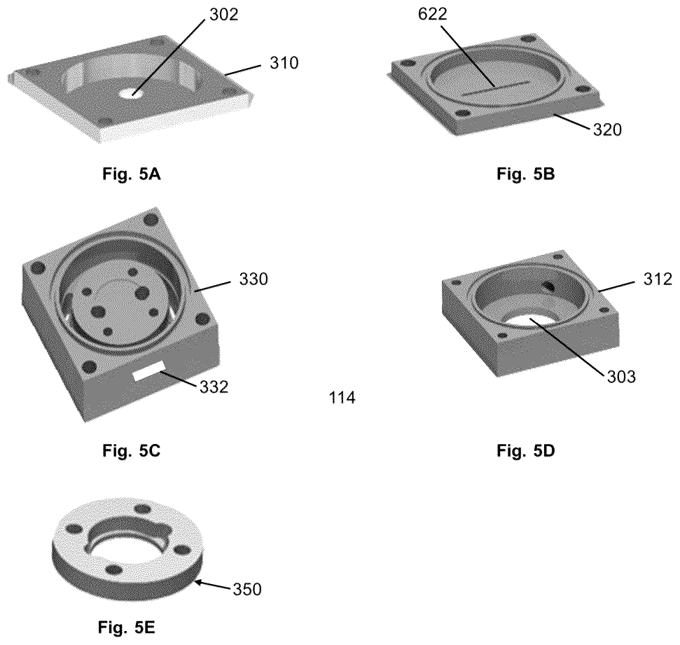

FIG. 5A to 5D shows various plates of the cascade impactor 114 in a closer view. FIG. 5A illustrates the design of the cap plate 310 which includes a hole in the center which is designed to be used as air inlet 302. The diameter of hole can affect the pressure of the airborne particles flowing into the cascade impactor 114.

FIG. 5B illustrates a design for the separator plate 320. The separators have narrow grooves (or slits) 601 with different diameters to separate larger airborne particles. There are 4 separator levels 600 in the module, responsible to separate particles larger than 2.5 um, 0.5 um, 0.25 um, and 0.1 um. Based on this design the smallest size pathogen which can be detected using this system is 0.1 um.

FIG. 5C illustrates a design for the sensor holder stage 330 which includes a side groove 332 to facilitate receiving the sensor board 140. in some embodiments, the sensor board 140 may be inserted in or out of the cascade impactor 114 from the side groove 332.

FIG. 5D illustrates a design of the end plate 312 according to one embodiment. The end plate 312 includes a hole in the center which may be designed to as the air outlet 303. The diameter of hole can affect the pressure of the airborne particles flowing out of the cascade impactor 114.

FIG. 5E illustrates a design for a reference sensor holder plate 350 of the cascaded sensory module 114 which is configured to hold a reference sensor (not shown in Figures). The reference sensor is not connected to any of the separator plates 320 and is out of the direct airflow path, for example, by being installed on the back side of the end plate 312 in an enclosed space out of the airflow path. The reference sensor may be used to provide reference measurements, for example for compensating errors in measurements of the sensor boards 140 effected by the airflow temperature and wear of the sensor boards 140, for example. The reference signals from the reference sensor may be transmitted to the processing unit 150 to facilitate compensating for the measurement errors.

FIG. 6A to 6C shows the sensor board 140 according to one embodiment.

The sensor board 114 may be a 2-sided printed circuit board with the top side being shown in FIG. 6A and the back side being shown on FIG. 6B. FIG. 6C shows the sensor board 114 being disposed on one or more of the stages 301 of the cascade impactor 114. The main component of the sensor board 114 is a coated crystal 610 installed on the sensor board 114. The coated crystal 610 is not shown in FIGS. 6A and 6B.

In some embodiments, more than one coated crystal 610 may be disposed on each side of the 2-sided sensor board 114. The coated crystals 610 are coated with specific chemical and biological materials which can react with certain pathogens, and as result will change the electromechanical properties of the crystals 610. Thus, the coated crystals 610 may demonstrate a varied electromechanical response with and without the presence of a pathogen. The biological coating on the coated crystals 610 depends on the pathogen(s) that is going to be monitored by the system 100. As an example, to monitor pathogens of type Influenza A, Dextran Sulfate can be used as the biological coating of the coated crystals 610. According to one embodiment, chemicals such as 11-mercaptoundecanoic acid, 4-morpholineethanesulfonic acid sodium salt, 1-ethyl-3-carbodiimidehydrochloride, and N-hydroxysuccinimide may be used to bind the biological coating to the crystal surface.

According to one embodiment, in order to measure the presence of a pathogen in vicinity or in contact with the coated crystals 610, the coated crystals 610 are being oscillated using electronics on the sensor board 114, while the electrical and physical characteristics of the crystals 610 are being measured with the electronic circuit.

On the top side of the sensor board 114, sensor pins 612 indicate the location where the coated crystals 610 are installed onto the sensor board 114. The crystal located between the sensor pins 612 and the initial readings will be transferred to a preliminary integrated circuit (IC) 620. The sensor board 140 may also include a temperature sensor 680 configured to monitor the temperature of the sensor board 140. The measurements from the temperature sensor 680 may be transmitted to the processing unit 150.

On the back side of the sensor board 114, connector pins 614 may be used to install additional coated crystals on the back of the sensor board 114. A second microcontroller 622 may be disposed on the back side, configured to process the readings from the coated crystals 610 on one side or both sides and to transmit the processed signals to the processing unit 150 through a connector terminal 640. The UV connectors 670 are for installation of UV LEDs.

The holder holes 690 may be used to secure the sensor board 114 to the sensor holder stage 330 and line up the sensor board with other stages and plates of the cascade sensor module 114.

FIG. 6C 2 instances of sensor board 140 within a partial cut out view of the cascade sensory module 114.

In some embodiments, the sensor board 140 disposed on the last stage of the cascade impactor 114 may include two coated crystals, one on the top side and one on the bottom side. In this case, the bottom crystal is not directly exposed to the air flow and the airborne particles, and hence may be used a reference sensor. Using the reference signal and its variations, the effect of external parameters such as temperature, humidity, electromagnetic fields, and vibrations may be compensated.

The output of all the sensor boards 140 in the cascade impactor 114 may is transferred to the processing unit 150. The processing unit 150 receives measurements from all the other sensors including but not limited to the temperature sensor 680, humidity sensor 123, UV sensors, and fluid level sensors and generate commands signals accordingly to control the operation of the system 100 including detection, cleaning and drying cycles, as well as the liquid and vacuum pumps and the UV LEDs operation. The processing unit 150 also stores and notifies user regarding the status of the pathogens in th ambient air and hence air quality. The data storage can be done locally on the device or remotely on a separate computer or a remote server through any network. The notification can be done either through local indicators (such as colored LED lamps or screens on the device) or through an application on the computer, server, or the intranet/internet network.

In some embodiments, the processing unit 150 may use two separate methods to analyze the sensor board 140 readings and determine the presence of airborne pathogens. The two methods are commonly known in literature as QCM and QCM-Z.

The QCM unit analyzes the sensor readings based on identifying the changes in the crystal sensor frequency. It counts the received signal and identifies the exact signal frequency and phase difference with the original signal. Both the frequency change and the phase difference can be used to identify if the crystal sensor has encountered pathogens of certain type or not. The level of variations can also be related to the level of pathogens existence in the air flow.

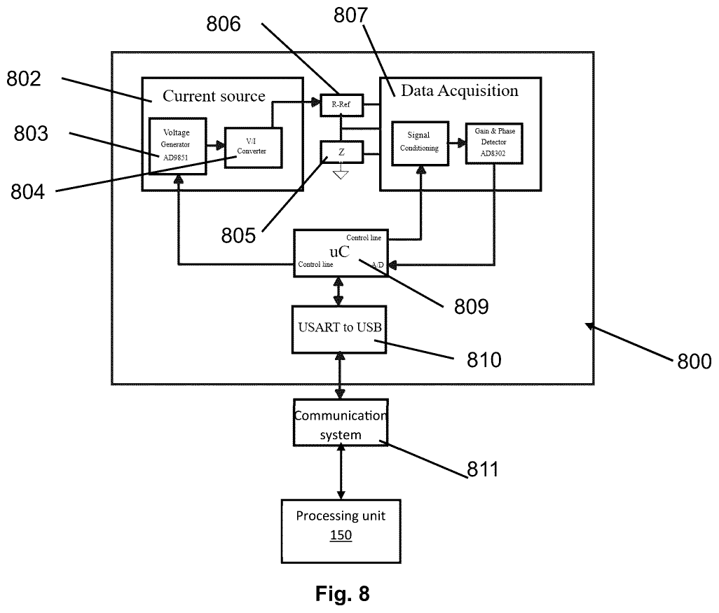

A QCM-Z unit 800 is shown in FIG. 8. The unit 800 is responsible for measuring the changes in the electrical characteristics of the coated crystals 610, specifically the crystal impedance within the range of 50K Hz to 20M Hz, for example. The QCM-Z unit 800 may be connected to the processing unit 150 through a connection converter 810 such as a USART to USB converter. Within the QCM-Z unit 1200, a current source module 802 includes a voltage generator 803 and a voltage to current converter 804. The current output from the current source module 802 is used to measure the impedance of the crystals using Z block 805, which is then being compared with the reference impedance through the R-ref block 806. The results of calculation will then be transferred to a microcontroller 809 through a data acquisition module 807. A communication module 811 may be used in some embodiments to transmit data between the unit 800 and the processing unit 150.

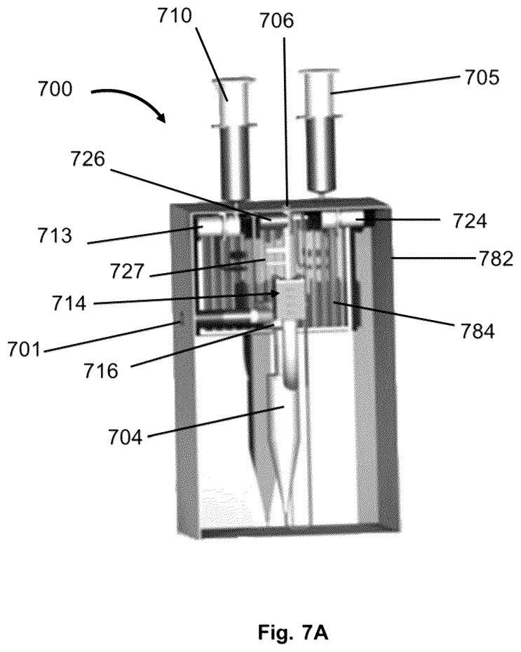

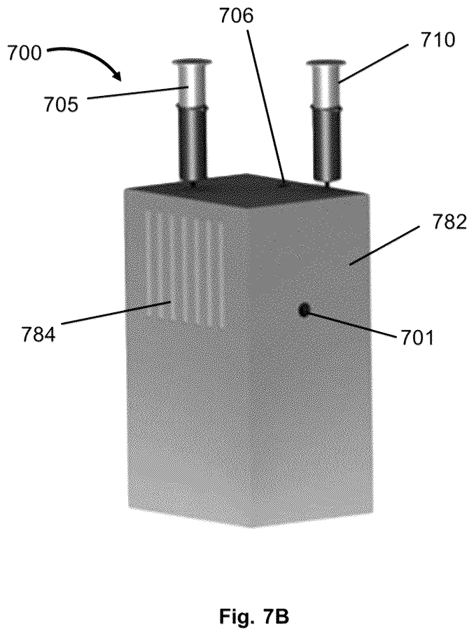

Referring to FIGS. 7A and 7B, another embodiment of a pathogen monitoring system 700 is shown. FIGS. 7A and 7B may include elements similar to those of FIGS. 2A and 2B, but within the respective 700 series of reference numbers, whether or not those elements are shown. FIG. 7A shows the front view of the disclosed monitoring system 700. The An enclosure 782 is disposed on the system 700 and is designed to prevent unwanted airflow and pathogens into the system 700. The only open part in the enclosure 782 may be a HEPA filter 784 which is configured to prevent pathogens from entering into the system 700 unintentionally. The system 700 includes two syringes, a cleaning syringe 710, which contains the cleaning fluid, and a waste syringe 705 configured to store waste fluid from the cleaning fluid. The syringes 710 and 705 may facilitate the process of loading the cleaning fluid and removing the waste fluid, while also acting as a visual indicator to facilitate visual inspection of the status of both fluids.

The system 700 further includes a cleaning peristaltic pump 713 configured to drive the cleaning fluid into the cascade impactor 714, and a waste peristaltic pump 724 configured to drive the waste fluid into the waste syringe 705. A pneumatic valve 726 will guide the air from the inlet 706 to the cascade sensory module 714, through a 4-way valve 727. The 4-way valve 727 is used to operate the path for different states (i.e. sending the air in for sampling, sending the cleaning fluid in for cleaning cycle, sending the clean air in for drying cycle, etc.). The air will pass through the cascade sensory module 714 to the cyclone 704. The air is being sucked into the system through the vacuum pump 716. After the pathogens are sampled, the air is being guided out through the air outlet 701.

FIG. 7B shows the back view of the monitoring system 700.

While specific embodiments have been described and illustrated, such embodiments should be considered illustrative only and not as limiting the invention as construed in accordance with the accompanying claims. While the above description provides examples of one or more apparatus, methods, or systems, it will be appreciated that other apparatus, methods, or systems may be within the scope of the claims as interpreted by one of skill in the art.

What is claimed is:

1. A system for monitoring of an airborne pathogen in ambient air, the system comprising:
a sampling unit comprising a collection inlet and configured to collect airborne particles from ambient air;
a cascade impactor comprising an inlet, an outlet, a plurality of filter stages and a sensor board disposed on a filter stage from the plurality of filter stages, the cascade impactor connected to the sampling unit from the inlet and configured to filter the airborne pathogen from the collected airborne particles, wherein the filtered airborne pathogen is identified by the sensor board; and
a processing unit connected to the sensor board and configured to detect the airborne pathogen identified by the sensor board.

2. The system of claim 1 further comprising a vacuum pump connected to the sampling unit through the cascade impactor and configured to suck the airborne particles from ambient air and drive the collected airborne particles through the cascade impactor.

3. The system of claim 1, wherein the sensor board is removable and wherein the sensor board is replaced with a new sensor board after the airborne pathogen is detected.

4. The system of claim 1 further comprising a cleaning system operably connected to the cascade impactor and configured to clear the cascade impactor and the sensor board thereon from the airborne pathogen.

5. The system of claim 4, wherein the cleaning system comprises a cleaning fluid stored in a fluid storage, and a fluid pump connected to the fluid storage, the fluid pump configured to drive the cleaning fluid from the fluid storage and through the cascade impactor.

6. The system of claim 5, wherein the cleaning system further comprises a fluid waste chamber connected to the outlet and configured to collect the cleaning fluid after exiting the cascade impactor.

7. The system of claim 6, wherein the cleaning system further comprises a cyclone disposed between the cascade impactor and the fluid waste chamber, and wherein the cyclone is configured to separate the airborne particles form the cleaning fluid.

8. The system of claim 5 further comprising a drying system configured to dry the cascade impactor from the cleaning fluid.

9. The system of claim 1, wherein the cascade impactor further comprises an ultraviolet light source to disinfect the sensor board from the airborne pathogen.

10. The sensor board of claim 1, wherein the sensor board comprises one or more coated crystals, wherein the sensor board identifies the airborne pathogen by a change in mechanical and/or electrical characteristic of the coated crystal once the airborne pathogen is in contact with the coated crystal.

11. The system of claim 10 further comprises a data transmission unit connected to the processing unit and configured to transmit data between the processing unit and a secondary device.

12. The system of claim 1 wherein the cascade impactor comprises a first sensor board disposed on a first filter stage from the plurality of filter stages and a second sensor board disposed on a second filter stage from the plurality of filter stages, and wherein the first sensor board and the second sensor board are different and are configured to the identify a first airborne pathogen and a second airborne pathogen respectively.

13. The system of claim 1 further comprising a reference sensor board not exposed to the airborne particles and configured to provide a reference signal to the processing unit for detection of the airborne pathogen.

14. The system of claim 1, wherein the processing unit is operably connected to a display unit to indicate the detection of the airborne pathogen to a user.

15. A method for screening an airborne pathogen in an environment, the method comprising:
sampling airborne particles from the environment and passing the airborne particles through a cascade impactor, wherein the cascade impactor comprises a plurality of filter stages and a sensor board disposed on a filter stage from the plurality of filter stages, and wherein at least one coated crystal is disposed on the sensor board;
measuring, at the sensor board, signals related to electromechanical characteristics of the at least one coated crystal;
receiving, at a processing unit, the measured signals from the sensor board; and
detecting, by the processing unit, presence of the airborne pathogen among the airborne particles, at least partially due to a change in the electromechanical characteristics of the at least one coated crystal when the airborne pathogen is in contact with the coated crystal.

16. The method of claim 15 further comprising receiving, at the processing unit, a reference signal from a reference sensor and wherein detecting presence of the airborne pathogen is determined by comparing the measured signals from the sensor board with the reference signal.

17. The method of claim 15 further comprising a cleaning cycle configured to clear the cascade impactor from the airborne pathogen once the airborne pathogen is detected, the cleaning cycle comprising one or more of:
disinfecting the coated crystals from the airborne pathogen using an ultraviolet light source disposed on the sensor board; and
cleaning the coated crystals and the cascade impactor by passing a cleaning fluid through the cascade impactor.

18. The method of claim 17 further comprising a drying cycle after the cleaning cycle.

19. The method of claim 15, wherein the sensor board is removable and wherein the sensor board is replaced with a new sensor board after the airborne pathogen is detected.
